(19) United States
(12) Patent Application Publication
(10) Pub. No.: US 2009/0146902 A1
(43) Pub. Date: Jun. 11, 2009

(54) Loop-Type Antenna and Antenna Array

(76) Inventors: Kuen-Hua Li, Taishan Township (TW); Wei-Hsiang Wang, Yuanshan Township (TW); Chang-Fa Yang, Taipei City (TW)

Correspondence Address: HDLS Patent & Trademark Services, P.O. BOX 220746, CHANTILLY, VA, 20153-0746, US

(21) Appl. No.: 11/937,581

(22) Filed: Nov. 9, 2007

(51) Int. Cl. H01Q 7/00; H01Q 11/12

(52) U.S. Cl. 343/867; 343/742

(57) ABSTRACT

A loop-type antenna for radio frequency identification includes a main body and a feed portion. The main body includes a loop member and at least one pair of coupled sections. The loop member has at least one gap. Each of the coupled sections is connected with one end of corresponding one of the at least one gap. The pair has identical extension direction. The feed portion is electrically connected with the loop member in the manner that the loop member is symmetrical in terms of the feed portion. An antenna array for radio frequency identification also is provided.

### BACKGROUND

1. Technical field

The present invention generally relates to antennas and, particularly, to a loop-type near-field antenna for radio frequency identification (RFID) and an antenna array using the loop-type near-field antenna.

2. Description of the Related Art

In the field of identification and recognition systems and, for example, in the field of radio frequency identification (RFID) systems, a system must be provided to allow for the communication between a reader and an item, such as a tagged item. The identification is typically accomplished by generating a field, such as magnetic field, which is capable of interacting and communicating with an identification element, such as a tag, positioned on the item. The field can either activate or power the tag, in a passive system, or the tag may include internal power sources to facilitate communications with the system reader. The field is typically generated by way of applying a current to a reader antenna. Accordingly, the reader antenna is powered and emits the field.

Generally, for the design of a near-field reader antenna which is suitable for identifying item level objects, it takes the intensity and direction of the current excited in the reader antenna into consideration, besides the return loss thereof. A strength and direction of the magnetic field generated from the reader antenna can be concluded from the intensity and direction of the current, and thereby a reliable read distance of the reader antenna can be acquired. In order to achieve the purpose of making the return loss of the reader antenna to be acceptable, there are two approaches that can be employed. One approach is to work out a suitable structure for the reader antenna, and the other is to add a matching circuit to the reader antenna.

Referring to FIGS. 1 and 2, a conventional planar half-wavelength dipole antenna 10 is provided. The half-wavelength dipole antenna 10 is a linear structure and has a feed portion 12 located at a central part (not labeled) thereof. A current intensity of a current excited in the half-wavelength dipole antenna 10 is maximal at the central part and gradually reduces to zero at both ends 13 thereof. As illustrated in FIG. 2, the half-wavelength dipole antenna 10 is designed to have a resonant frequency of about 915 MHz and a small return loss at the resonant point of about −25 dB. Because the current excited in the half-wavelength dipole antenna 10 usually flows in a same direction, if the linear half-wavelength dipole antenna 10 is circularized as a loop-type antenna, a loop current excited in the resultant loop antenna ought to flows in a same direction along the loop. As to a loop-type antenna, an impedance thereof generally is inductive and primarily generates a magnetic field in the near field. Therefore, the impedance of the loop antenna is immune to dielectric materials and thus the loop antenna is rather suitably for identifying item-level objects. However, due to the configuration of the half-wavelength dipole antenna 10 will be completely changed after being simply circularized, a return loss thereof would be expectedly degraded and thus the performance of the resultant loop-type antenna is unsatisfying.

### BRIEF SUMMARY

The present invention is to provide a loop-type antenna with a high performance, for radio frequency identification (RFID).

Furthermore, the present invention is to provide an antenna array includes a plurality of loop-type antenna with a high performance, for radio frequency identification.

A loop-type antenna for radio frequency identification, in accordance with a present embodiment, comprises a main body and a feed portion. The main body comprises a loop member and at least one pair of coupled sections. The loop member has at least one gap. Each of the coupled sections is connected with one end of corresponding one of the at least one gap. The pair has identical extension direction. The feed portion is electrically connected with the loop member in the manner that the loop member is symmetrical in terms of the feed portion.

An antenna array for radio frequency identification, in accordance with another present embodiment, comprises a plurality of loop-type antennas. Each of the loop-type antennas comprises a main body and a feed portion. The main body comprises a loop member and at least one pair of coupled sections. The loop member has at least one gap. Each of the coupled sections is connected with one end of corresponding one of the at least one gap. The pair has identical extension direction. The feed portion is electrically connected with the loop member in the manner that the loop member is symmetrical in terms of the feed portion.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a planar half-wavelength dipole antenna, in the related art.

FIG. 2 is a return loss diagram for the planar half-wavelength dipole antenna of FIG. 1.

FIG. 3 is a schematic view of a loop-type antenna, in accordance with a first embodiment.

FIG. 4 is a diagram of return loss for the loop-type antenna of FIG. 3.

FIG. 5 is a schematic view of another loop-type antenna similar to that of FIG. 3.

FIG. 6 is a schematic view of a loop-type antenna, in accordance with a second embodiment.

FIG. 7 is a diagram of return loss for the loop-type antenna of FIG. 6.

FIG. 8 is a schematic view of a unidirectional antenna array, in accordance with a third embodiment.

FIG. 9 is a schematic view of a loop-type antenna, in accordance with a fourth embodiment.

FIG. 10 is a diagram of return loss for the loop-type antenna of FIG. 9.

FIG. 11 a schematic view of an omnidirectional antenna array, in accordance with a fifth embodiment.

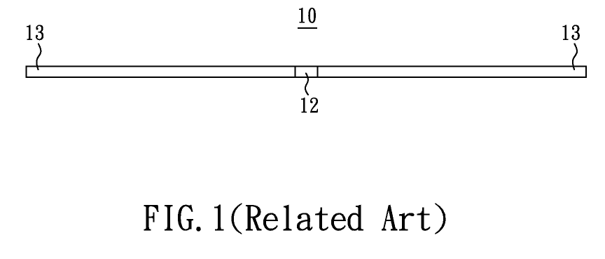

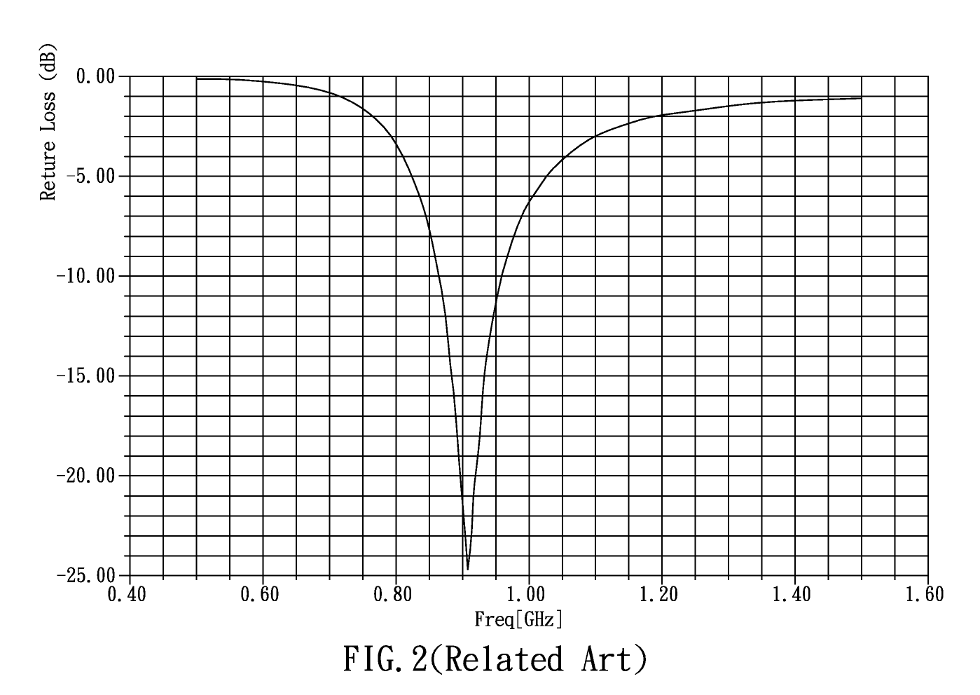

### DETAILED DESCRIPTION

### Embodiment One

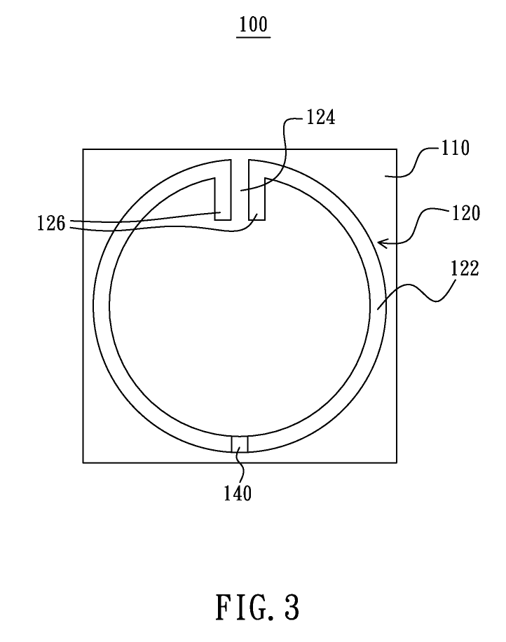

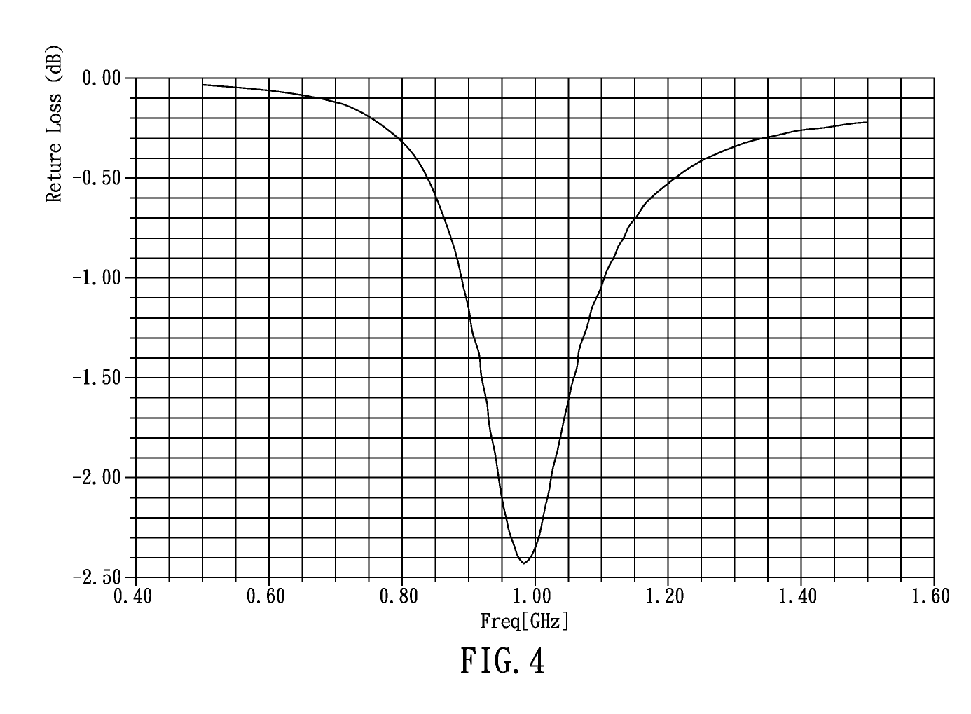

Referring to FIGS. 3 and 4, a loop-type antenna 100 for radio frequency identification, in accordance with a first embodiment, is provided. The loop-type antenna 100 comprises a main body 120 and a feed portion 140.

The main body 120 is electrically conductive and preferably formed on an insulating substrate 110. The main body 120 comprises an electrically conductive single turn loop member 122 and one pair of coupled sections 126. The single turn loop member 122 has one gap 124. Each section of the pair 126 is connected with one end of the gap 124. The pair 126 has identical extension direction. In the first embodiment, the extension direction faces an internal area of the single turn loop member 122. Currents respectively flowing in the pair 126 are substantially counteracted with each other. In other words, the small currents flowing to the ends of the main body 120 are counteracted so that the entire current intensity of the current flowing along the length of the single turn loop member 122 is more uniform. As a result, a sufficient near-field magnetic field generated from the single turn loop member 122 can be obtained, which facilitates the loop-type antenna 100 to be endowed with a high performance.

In order to form a same-direction loop current in the loop-type antenna 100 to reinforce the magnetic field substantially orthogonal to the plane of the single turn loop member 122, a length of the main body 120 (i.e., generally the total lengths of the single turn loop member 120 and the pair of coupled sections 126) is preferably close to but no more than λ/2, wherein the λ is an operating wavelength of the radio frequency identification. The operating wavelength λ satisfies the equation that λ=c/f, wherein c is approximately equal to 3×10⁸ meters per second (m/s) and f is an operating frequency of the radio frequency identification. For example, when the operating frequency f of the radio frequency identification is in the 900 MHz frequency range, the length of the main body 120 rather suitably is close to but no more than about 16 centimeters correspondingly.

The feed portion 140 is electrically connected with the single turn loop member 122 of the main body 120 in the manner that the single turn loop member 122 is substantially symmetrical in terms of the feed portion 140. The feed portion 140 is configured for being connected to an RF power source, e.g., an RFID reader/transceiver, so as to allow a sinusoidal/cosinusoidal current passing therethrough to feed the main body 120.

As shown in FIG. 3, for the purpose of illustration, the single turn loop member 122 has a ring shape and the sections of the pair 126 are two straight lines parallel to each other. A return loss of the loop-type antenna 100 is about −2.5 dB at a resonant point thereof (as shown in FIG. 4). When an input power is about 1 watt, a reliable read distance of the loop-type antenna 100 can reach about 7 centimeters for an item level tag having a diameter of about 9 millimeters. When the input power is reduced to be about 250 milliwatts, a reliable read distance thereof can reach about 5 centimeters for the item level tag having the diameter of about 9 millimeters.

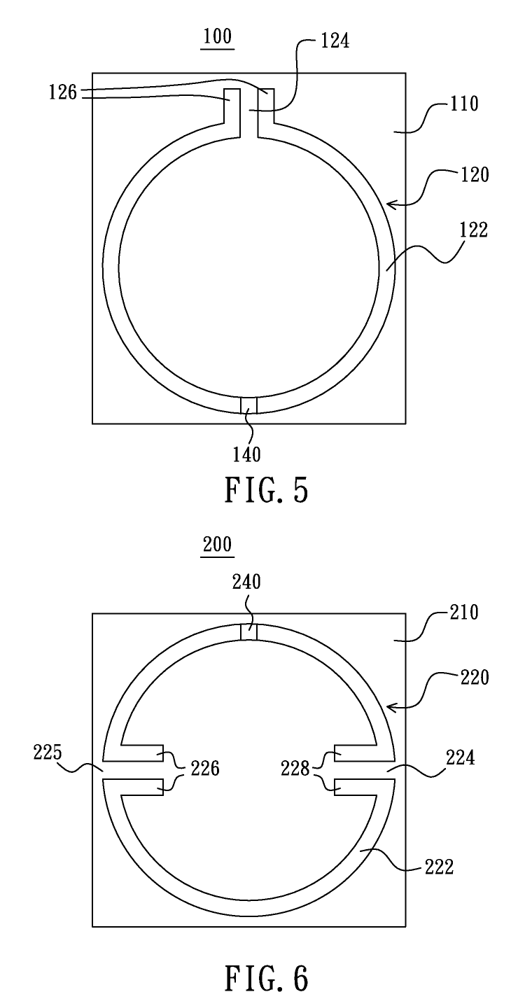

It is understood that the single turn loop member 122 is not limited to a ring shape. Other shapes, such as oval, square, or rectangular ring-shaped are acceptable as well. Each section of the pair 126 is not limited to having the extension direction that faces the internal area of the single turn loop member 122. An extension direction, for example, that faces an external area (as shown in FIG. 5) will do. Furthermore, the sections of the pair 126 are not limited to two straight lines parallel to each other, so long as the currents flowing in the pair 126 are substantially counteracted with each other.

### Embodiment Two

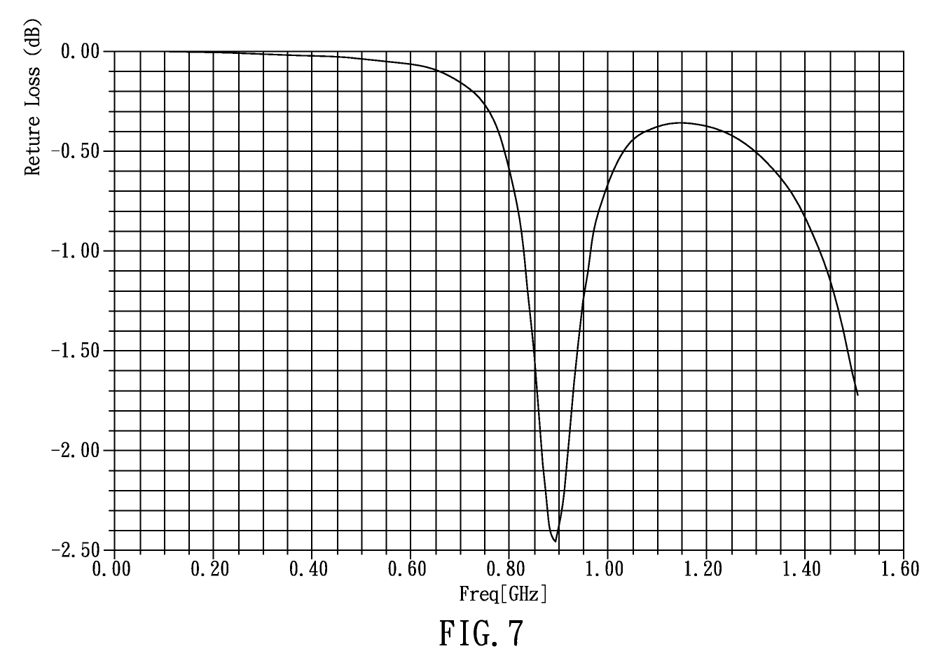

Referring to FIGS. 6 and 7, a loop-type antenna 200 for radio frequency identification, in accordance with a second embodiment, is provided. The loop-type antenna 200 comprises a main body 220 and a feed portion 240.

The main body 220 is electrically conductive and preferably formed on an insulating substrate 210. The main body 220 comprises an electrically conductive single turn loop member 222 and two pairs of coupled sections 226 and 228. The single turn loop member 222 has two gaps 224 and 225. Each section of the pair 226 is connected with one end of the gap 225. Each section of the pair 228 is connected with one end of the gap 224. The two gaps 224, 225 are disposed at two ends of a diameter of the single turn loop member 222. The sections of each pair 226 or 228 have identical extension direction. In the second embodiment, the extension directions face an internal area of the single turn loop member 222. It is noted that the extension direction of the pair 226 is unnecessary to be the same as that of the pair 228. For example, one can face inwardly and the other faces outwardly. Currents respectively flowing in each of the pairs 226, 228 are substantially counteracted with each other, so that the entire current intensity of the current flowing along the single turn loop member 222 is more uniform. As a result, a sufficient near-field magnetic field generated from the single turn loop member 222 can be obtained, which facilitates the loop-type antenna 200 to be endowed with a high performance.

In order to form a same-direction loop current in the loop-type antenna 200 to reinforce the magnetic field substantially orthogonal to the plane of the single turn loop member 222, a length of main body 220 is preferably close to but no more than λ/2, wherein the λ is an operating wavelength of the radio frequency identification.

The feed portion 240 is electrically connected with the single turn loop member 222 of the main body 220 in the manner that the single turn loop member 222 is substantially symmetrical in terms of the feed portion 240. The feed portion 240 is configured for being connected to an RF power source, e.g., an RFID reader, so as to allow a sinusoidal/cosinusoidal current passing therethrough to feed the main body 220.

As shown in FIG. 6, for the purpose of illustration, the single turn loop member 222 has ring shape and the sections of each pair 226 or 228 are two straight lines parallel to each other. A return loss of the loop-type antenna 200 is about −2.5 dB at a resonant point thereof (as shown in FIG. 7). When an input power is about 250 milliwatts, a reliable read distance of the loop-type antenna 200 can reach about 6 centimeters for an item level tag having a diameter of about 9 millimeters. In addition, the loop-type antenna 200 has a current intensity more uniform than that of the loop-type antenna 100, due to the configuration of the two pairs 226, 228.

It is understood that the single turn loop member 222 is not limited to a ring shape. Other shapes, such as oval, square, or rectangular ring-shaped are acceptable as well. Each section of each pair 226 or 228 is not limited to have the extension direction that faces the internal area of the single turn loop member 222. An extension direction, for example, that faces an external area of the single turn loop member 222 will do. Furthermore, the sections of each pair 226 or 228 are not limited to two straight lines parallel to each other, so long as the currents flowing in each of the pairs 226, 228 are substantially counteracted with each other. In addition, the electrically conductive loop member 222 is not limited to have two pairs 226, 228 and may have more than two pairs.

### Embodiment Three

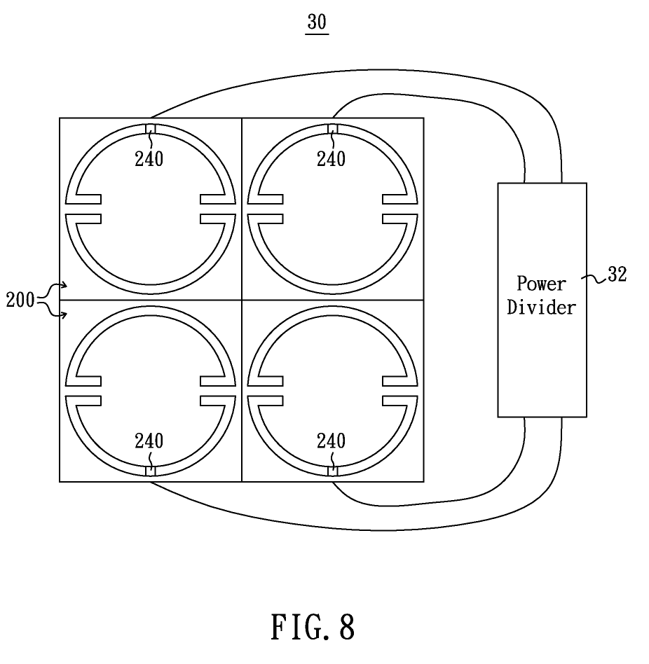

Referring to FIG. 8, an antenna array 30, in accordance with a third embodiment, is provided. The antenna array 30 comprises four loop-type antennas 200 of the second embodiment, arranged in a 2×2 array, in order to obtain an intensive read/write range. The four loop-type antennas 200 are coplanar. The antenna array 30 further comprises a power divider 32, the feed portion 240 of each of the four loop-type antennas 200 is electrically connected to the power divider 32 via an RF cable (not labeled), respectively so that each of the four loop-type antennas 200 can be activated by a power source (not shown) connected to or built in the power divider 32. The power divider 32 can be controlled by an RFID reader (not shown). It is understood that part or all of the loop-type antennas 200 can be replaced by the loop-type antenna 100 as above described in the first embodiment.

### Embodiment Four

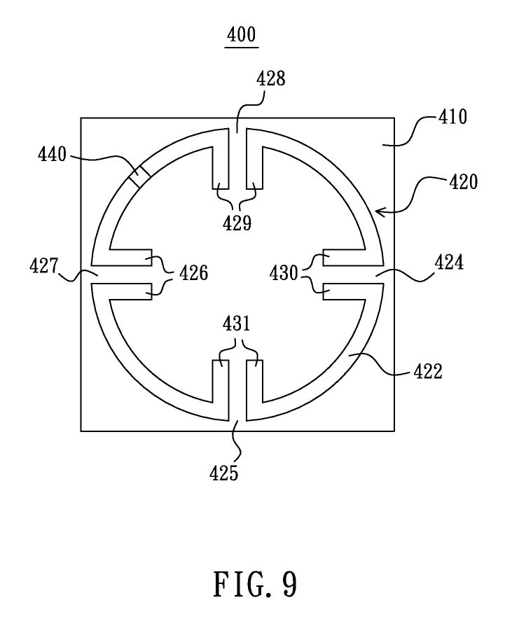

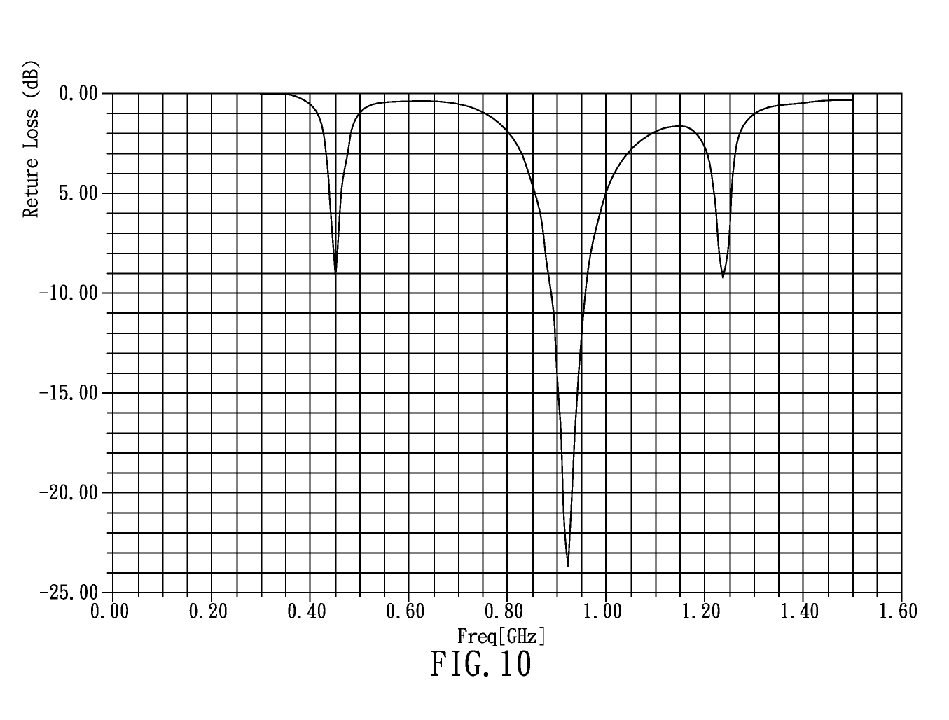

Referring to FIGS. 9 and 10, a loop-type antenna 400 for radio frequency identification, in accordance with a fourth embodiment, is provided. The loop-type antenna 400 comprises a main body 420 and a feed portion 440.

The main body 420 is electrically conductive and preferably formed on an insulating substrate 410. The main body 420 comprises an electrically conductive single turn loop member 422 and four pairs of coupled sections 426, 429, 430, 431. The single turn loop member 422 has four gaps 424, 425, 427, 428. Each section of one of the pairs 426, 429, 430, 431 is connected with one end of the corresponding one of the gaps. For example, each section of the pair 426 is connected with one end of the gap 427. The four gaps 424, 425, 427, 428 are disposed at ends of two diameters of the single turn loop member 422. The sections of each pair 426, 429, 430, 431 have identical extension direction. In the fourth embodiment, the extension directions face an internal area of the single turn loop member 422. It is noted that the extension direction of one pair 426, 429, 430, or 431 is unnecessary to be the same as those of the others. Currents flowing in each of the pairs 426, 429, 430, 431 are substantially counteracted with each other, so that the entire current intensity of the current flowing along the length of the single turn loop member 422 is more uniform. As a result, a sufficient near-field magnetic field generated from the single turn loop member 422 can be obtained, which facilitates the loop-type antenna 400 to be endowed with a high performance

In order to generate reverse directions of loop currents in the loop-type antenna 400, a length of the main body 420 is preferably more than λ/2, wherein the λ is an operating wavelength of the radio frequency identification. More preferably, the length of the main body 420 is more than λ/2 and no more than λ so that magnetic fields in different directions can be generated due to the reverse directions of the loop currents.

The feed portion 440 is electrically connected with the single turn loop member 422 of the main body 420 in the manner that the single turn loop member 422 is substantially symmetrical in terms of the feed portion 440. The feed portion 440 is configured for being connected to an RF power source, e.g., an RFID reader, so as to allow a sinusoidal/cosinusoidal current passing therethrough to feed to the main body 420.

As shown in FIG. 9, for the purpose of illustration, the main body 420 has a length of about λ. The single turn loop member 422 has a ring shape and has a diameter of about 100 millimeters. The sections of each of the pairs 426, 429, 430, 431 are two straight lines parallel to each other, and each of the pairs 426, 429, 430, 431 has a length of about 28.5 millimeters. A return loss of the loop-type antenna 400 is about −24 dB at a resonant point thereof (as shown in FIG. 10). When an input power is about 1 watt, a reliable read distance of the loop-type antenna 400 can reach about 15˜20 centimeters for an item level tag having a diameter of about 9 millimeters.

It is understood that the single turn loop member 422 is not limited to a ring shape. Other shapes, such as oval, square, or rectangular ring-shaped are acceptable as well. Each section of each of the pairs 426, 429, 430, 431 is not limited to have the extension direction that faces the internal area of the single turn loop member 422. An extension direction that faces an external area of the single turn loop member 422 will do. Furthermore, the sections of each of the pairs 426, 429, 430, 431 are not limited to be two straight lines parallel to each other, so long as the currents flowing in each of the pairss 426, 429, 430, 431 are substantially counteracted with each other. In addition, the electrically conductive loop member 422 is not limited to have four pairs 426, 429, 430, 431 and may have any pair.

### Embodiment Five

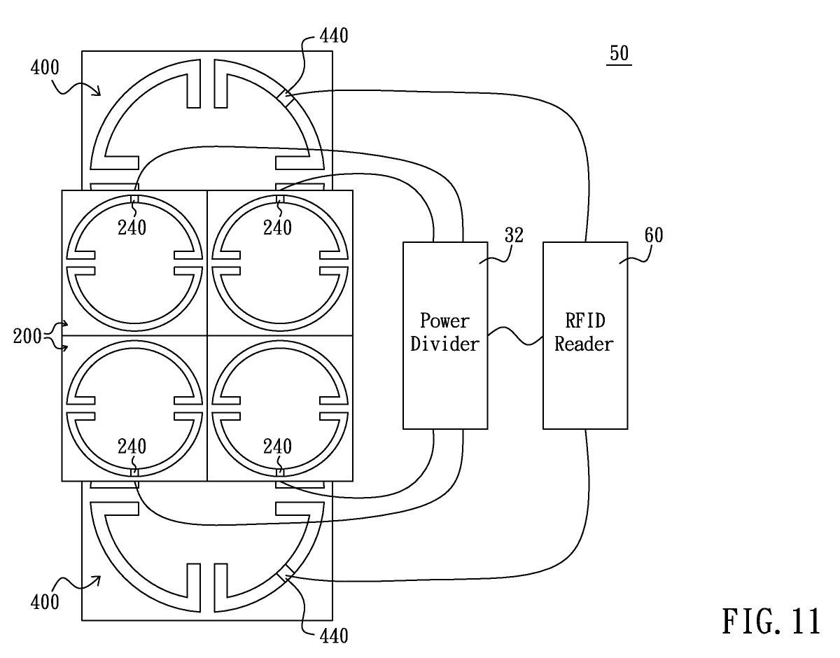

Referring to FIG. 11, an antenna array 50, in accordance with a fifth embodiment, is provided. The antenna array 50 comprises a plurality of loop-type antennas divided into a first layer and a second layer. The first layer comprises a plurality of loop-type antennas 200 to generate a perpendicular magnetic field. The second layer comprises a plurality of loop-type antennas 400 to generate a horizontal magnetic field so that both perpendicular magnetic field and horizontal magnetic field can be obtained.

For the purpose of illustration, the first layer comprises four loop-type antennas 200 and the second layer comprises two loop-type antennas 400. The four loop-type antennas 200 are arranged in a coplanar 2×2 array. The two loop-type antennas 400 are arranged coplanar as well. The first layer is above the second layer in the fifth embodiment. The four loop-type antennas 200 are, respectively, electrically connected to the power divider 32 and then connected to a RFID reader 60. The two loop-type antennas 400 are, respectively, directly electrically connected to the RFID reader 60. Such an arrangement makes each of the loop-type antennas 200 and 400 able to be activated by the RFID reader 60 in turn.

When input power for each of the loop-type antennas 200 is about 250 milliwatts and input power for each of the four loop-type antennas 400 is about 1 watt, a reliable read distance of the loop-type antennas 200 is about 6˜9 centimeters and a reliable read distance of the loop-type antennas 400 is about 10˜20 centimeters.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A loop-type antenna for radio frequency identification, comprising:
a main body, comprising:
a loop member, having at least one gap; and
at least one pair of coupled sections, each of the coupled sections being connected with one end of the gap, the pair having identical extension direction; and
a feed portion electrically connected with the loop member in the manner that the loop member is symmetrical in terms of the feed portion.

2. The loop-type antenna according to claim 1, wherein the main body has a length close to but no more than λ/2, and λ is an operating wavelength of the radio frequency identification.

3. The loop-type antenna according to claim 1, wherein the main body has a length more than λ/2, and λ is an operating wavelength of the radio frequency identification.

4. The loop-type antenna according to claim 3, wherein the length is no more than λ.

5. The loop-type antenna according to claim 1, wherein the extension direction faces an internal area of the loop member.

6. The loop-type antenna according to claim 1, wherein the pair is two straight lines parallel to each other.

7. The loop-type antenna according to claim 1, wherein the number of the gaps and the number of the pairs are plural and each of the gaps corresponds to one of the pairs.

8. The loop-type antenna according to claim 7, wherein the number of the gaps and the number of the pairs are two, and the gaps are disposed at two ends of a diameter of the loop member.

9. The loop-type antenna according to claim 7, wherein the number of the gaps and the number of the pairs are four, and the gaps are disposed at ends of two diameters of the loop member.

10. An antenna array for radio frequency identification, comprising a plurality of loop-type antennas, each of the loop-type antennas comprising:
a main body, comprising:
a loop member, having at least one gap; and
at least one pair of coupled sections, each of the coupled sections being connected with one end of the gap, the pair having identical extension direction; and
a feed portion electrically connected with the loop member in the manner that the loop member is symmetrical in terms of the feed portion.

11. The antenna array according to claim 10, wherein the plurality of loop-type antennas are coplanar.

12. The antenna array according to claim 10, wherein each of the loop-type antennas is activated by a power source in turn.

13. The antenna array according to claim 10, wherein each of the loop-type antennas is activated by a power divider connected to a power source.

14. The antenna array according to claim 10, wherein the antenna array is divided into:
a first layer, comprising the loop-type antennas whose main bodies have a length close to but no more than λ/2; and
a second layer, comprising the loop-type antennas whose main bodies have a length more than λ/2 and no more than λ;
wherein λ is an operating wavelength of the radio frequency identification.

15. The antenna array according to claim 14, wherein the number of the gaps and the number of the pairs of each loop-type antenna in the first layer are two, and the gaps are disposed at two ends of a diameter of the loop member thereof.

16. The antenna array according to claim 14, wherein the number of the gaps and the number of the pairs of each loop-type antenna in the second layer are four, and the gaps are disposed at ends of two diameters of the loop member thereof.

17. The antenna array according to claim 10, wherein the extension direction faces an internal area of the loop member.

18. The antenna array according to claim 10, wherein the pair is two straight lines parallel to each other.
